(19) United States
(12) Patent Application Publication
(10) Pub. No.: US 2021/0073050 A1
(43) Pub. Date: Mar. 11, 2021

(54) RE-DISPATCHING TASKS ON ASSOCIATED PROCESSORS TO REDUCE LOCK CONTENTION

(71) Applicant: International Business Machines Corporation, Armonk, NY (US)

(72) Inventors: Clint A. Hardy, Tucson, AZ (US); Lokesh M. Gupta, Tucson, AZ (US); Trung N. Nguyen, Vail, AZ (US); Seamus Burke, Tucson, AZ (US)

(73) Assignee: International Business Machines Corporation, Armonk, NY (US)

(21) Appl. No.: 16/567,932

(22) Filed: Sep. 11, 2019

(51) Int. Cl. G06F 9/52; G06F 9/48; G06F 3/06

(52) U.S. Cl. CPC G06F 9/524; G06F 9/4856; G06F 3/067; G06F 3/0653; G06F 3/0604

(57) ABSTRACT

A method is disclosed to reduce lock contention in a data storage system. The method dispatches, on a first processor core, a task configured to acquire a lock on a data storage resource, such as memory. The method then determines whether the first processor core is associated with the data storage resource. If the first processor core is not associated with the data storage resource, the method re-dispatches the task on a second processor core that is associated with the data storage resource. In certain embodiments, the task is only re-dispatched on the second processor core if an amount of effort required to acquire the lock is above a selected threshold. If, on the other hand, the first processor core is associated with the data storage resource, the method executes the task on the first processor core. A corresponding system and computer program product are also disclosed.

### BACKGROUND

### Field of the Invention

This invention relates to apparatus and methods to reduce lock contention in storage systems such as the IBM DS8000™ enterprise storage system.

### Background of the Invention

In enterprise storage systems such as the IBM DS8000™ enterprise storage system, multiple servers may be provided to ensure that data is always available to connected hosts. When one server fails, the other server may pick up the I/O load of the failed server to ensure that I/O is able to continue between hosts and backend storage volumes, which may be implemented on storage devices (e.g. hard disk drives, solid state drives, etc.) within the enterprise storage system. This process may be referred to as a “failover.” To provide the above-described functionality, each server may contain a processor complex (also known as a “central electronics complex”) that includes one or more central processing units (CPUs) and other hardware configured to process I/O requests received from host systems. During normal operation (when both servers are operational), the servers may manage I/O to different logical subsystems (LSSs) within the enterprise storage system. For example, in certain configurations, a first server may handle I/O to even LSSs, while a second server may handle I/O to odd LSSs.

Each server or processor complex in an IBM DS8000™ enterprise storage system may include several processor chips and each processor chip may contain several processor cores. Each processor chip and associated processor cores may have associated memory that can be accessed faster than the memory of other processor chips. When acquiring locks, processor cores on a chip may acquire locks on their associated memory faster than they can acquire locks on the memory of other processor chips. In the current design of the IBM DS8000™ enterprise storage system, I/O operations may be executed by any processor core within any chip and locks on memory may be acquired by any processor core for memory of any chip. However, the time needed for a processor core to acquire a lock in its associated memory versus the memory of another chip may differ significantly. This difference is the result of cache coherency operations and other overhead that needs to be performed when a processor core accesses the memory of another processor chip.

In view of the foregoing, what are needed are apparatus and methods to reduce lock contention in data storage systems such as the IBM DS8000™ enterprise storage system. Ideally, such apparatus and methods will significantly improve performance when acquiring locks in data storage systems.

### SUMMARY

The invention has been developed in response to the present state of the art and, in particular, in response to the problems and needs in the art that have not yet been fully solved by currently available apparatus and methods. Accordingly, embodiments of the invention have been developed reduce lock contention in data storage systems. The features and advantages of the invention will become more fully apparent from the following description and appended claims, or may be learned by practice of the invention as set forth hereinafter.

Consistent with the foregoing, a method is disclosed to reduce lock contention in a data storage system. The method dispatches, on a first processor core, a task configured to acquire a lock on a data storage resource, such as memory. The method then determines whether the first processor core is associated with the data storage resource. If the first processor core is not associated with the data storage resource, the method re-dispatches the task on a second processor core that is associated with the data storage resource. In certain embodiments, the task is only re-dispatched on the second processor core if an amount of effort required to acquire the lock is above a selected threshold. If, on the other hand, the first processor core is associated with the data storage resource, the method executes the task on the first processor core.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level block diagram showing an exemplary network environment in which apparatus and methods in accordance with the invention may be implemented;

FIG. 2 is a high-level block diagram showing an exemplary storage system in which apparatus and methods in accordance with the invention may be implemented;

FIG. 3 is a high-level block diagram showing multiple processor chips, each having multiple processor cores, cache, and associated memory;

FIG. 4 is a high-level block diagram showing cores, within the processor chips, accessing local (i.e., associated) and remote (i.e., non-associated) memory;

FIG. 5 is a high-level block diagram showing acquisition of locks by cores within the processor chips;

FIG. 6 is a flow diagram showing one embodiment of a method for reducing lock contention in a data storage system;

FIG. 7 is a flow diagram showing another embodiment of a method for reducing lock contention in a data storage system; and

FIG. 8 shows the re-dispatch of a task from a non-associated processor core to an associated processor core in order to improve performance.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The present invention may be embodied as an apparatus, method, and/or computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage system, a magnetic storage system, an optical storage system, an electromagnetic storage system, a semiconductor storage system, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage system via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on a user's computer, partly on a user's computer, as a stand-alone software package, partly on a user's computer and partly on a remote computer, or entirely on a remote computer or server. In the latter scenario, a remote computer may be connected to a user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention may be described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

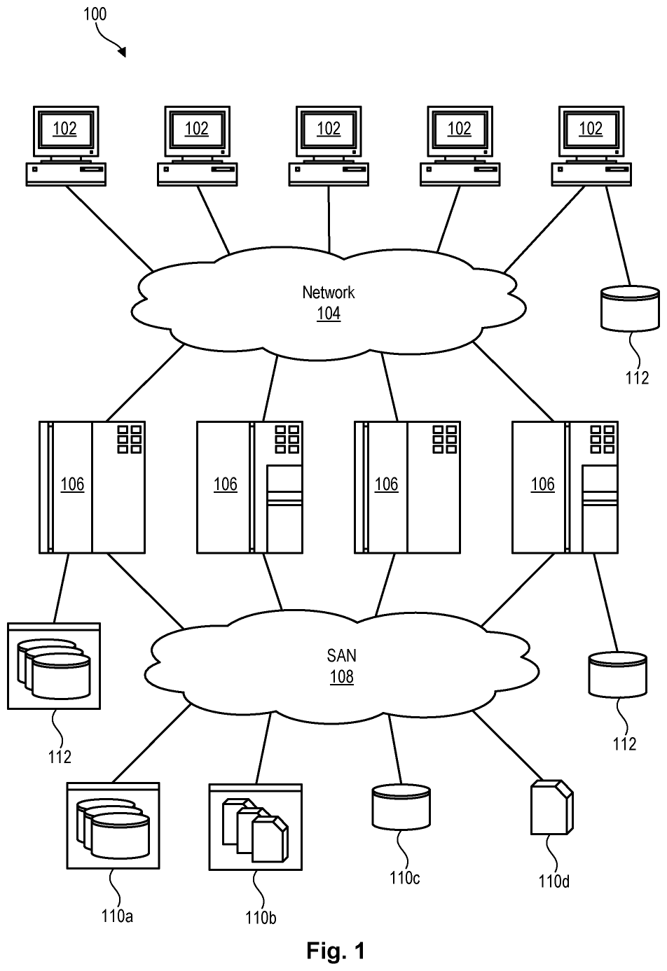

Referring to FIG. 1, one example of a network environment 100 is illustrated. The network environment 100 is presented to show one example of an environment where apparatus and methods in accordance with the invention may be implemented. The network environment 100 is presented by way of example and not limitation. Indeed, the apparatus and methods disclosed herein may be applicable to a wide variety of different network environments in addition to the network environment 100 shown.

As shown, the network environment 100 includes one or more computers 102, 106 interconnected by a network 104. The network 104 may include, for example, a local-area-network (LAN) 104, a wide-area-network (WAN) 104, the Internet 104, an intranet 104, or the like. In certain embodiments, the computers 102, 106 may include both client computers 102 and server computers 106 (also referred to herein as “hosts” 106 or “host systems” 106). In general, the client computers 102 initiate communication sessions, whereas the server computers 106 wait for and respond to requests from the client computers 102. In certain embodiments, the computers 102 and/or servers 106 may connect to one or more internal or external direct-attached storage systems 112 (e.g., arrays of hard-storage drives, solid-state drives, tape drives, etc.). These computers 102, 106 and direct-attached storage systems 112 may communicate using protocols such as ATA, SATA, SCSI, SAS, Fibre Channel, or the like.

The network environment 100 may, in certain embodiments, include a storage network 108 behind the servers 106, such as a storage-area-network (SAN) 108 or a LAN 108 (e.g., when using network-attached storage). This network 108 may connect the servers 106 to one or more storage systems 110, such as arrays 110a of hard-disk drives or solid-state drives, tape libraries 110b, individual hard-disk drives 110c or solid-state drives 110c, tape drives 110d, CD-ROM libraries, or the like. To access a storage system 110, a host system 106 may communicate over physical connections from one or more ports on the host 106 to one or more ports on the storage system 110. A connection may be through a switch, fabric, direct connection, or the like. In certain embodiments, the servers 106 and storage systems 110 may communicate using a networking standard such as Fibre Channel (FC) or iSCSI.

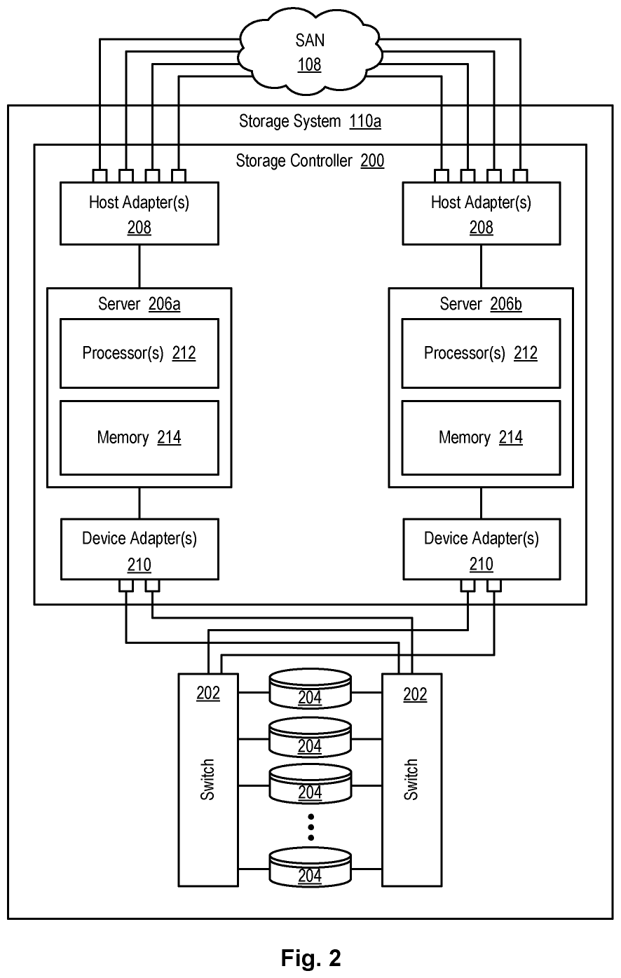

Referring to FIG. 2, one example of a storage system 110a containing an array of hard-disk drives 204 and/or solid-state drives 204 is illustrated. The internal components of the storage system 110a are shown since apparatus and methods in accordance with the invention may be implemented within such a storage system 110a. As shown, the storage system 110a includes a storage controller 200, one or more switches 202, and one or more storage drives 204, such as hard-disk drives 204 and/or solid-state drives 204 (e.g., flash-memory-based drives 204). The storage controller 200 may enable one or more host systems 106 (e.g., open system and/or mainframe servers 106 running operating systems such z/OS, zVM, or the like) to access data in the one or more storage drives 204.

In selected embodiments, the storage controller 200 includes one or more servers 206a, 206b. The storage controller 200 may also include host adapters 208 and device adapters 210 to connect the storage controller 200 to host systems 106 and storage drives 204, respectively. Multiple servers 206a, 206b may provide redundancy to ensure that data is always available to connected host systems 106. Thus, when one server 206a fails, the other server 206b may pick up the I/O load of the failed server 206a to ensure that I/O is able to continue between the host systems 106 and the storage drives 204. This process may be referred to as a “failover.”

In selected embodiments, each server 206 includes one or more processors 212 and memory 214. The memory 214 may include volatile memory (e.g., RAM) as well as non-volatile memory (e.g., ROM, EPROM, EEPROM, hard disks, flash memory, etc.). The volatile and non-volatile memory may, in certain embodiments, store software modules that run on the processor(s) 212 and are used to access data in the storage drives 204. These software modules may manage all read and write requests to logical volumes in the storage drives 204.

One example of a storage system 110a having an architecture similar to that illustrated in FIG. 2 is the IBM DS8000™ enterprise storage system. The DS8000™ is a high-performance, high-capacity storage controller providing disk and solid-state storage that is designed to support continuous operations. Nevertheless, the techniques disclosed herein are not limited to the IBM DS8000™ enterprise storage system 110a, but may be implemented in any comparable or analogous storage system 110, regardless of the manufacturer, product name, or components or component names associated with the system 110. Any storage system that could benefit from one or more embodiments of the invention is deemed to fall within the scope of the invention. Thus, the IBM DS8000™ is presented only by way of example and not limitation.

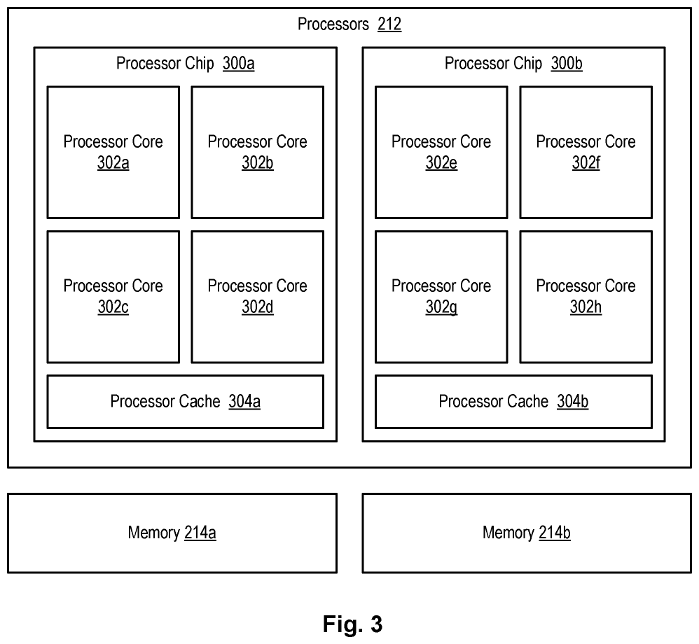

Referring to FIG. 3, as previously mentioned, each server 206 in an IBM DS8000™ enterprise storage system may contain a processor complex (also known as a “central electronics complex”) that includes one or more central processing units (CPUs) and other hardware configured to process I/O requests received from host systems 106. These processor complexes 212 may include multiple processor chips 300 and each processor chip 300 may contain several processor cores 302. Each processor chip 300 and associated processor cores 302 may have associated memory 214 that can be accessed faster than the memory 214 of other processor chips 300. When acquiring locks, processor cores 302 on a chip 300 may also acquire locks on their associated memory 214 faster than they can acquire locks on the memory 214 of other processor chips 300. In the current design of the IBM DS8000™ enterprise storage system, I/O operations may be executed by any processor core 302 within any chip 300 and locks on memory 214 may be acquired by any processor core 302 for memory 214 of any chip 300. However, the time needed for a processor core 302 to acquire a lock in its associated memory 214 may be much shorter than that needed to acquire a lock in the memory 214 of another processor chip 300. This may be the result of cache coherency operations and other overhead that needs to be performed when a processor core 302 accesses the memory 214 of another processor chip 300.

FIG. 3 shows an exemplary processor complex 212 that includes two processor chips 300a, 300b, with the first processor chip 300a containing four processor cores 302a-d, and the second processor chip 300b containing four processor cores 302e-h. In reality, a server 206 may include more processor chips 300 than what is illustrated and each processor chip 300 may include more or fewer processor cores 302 than what is illustrated. For example, a POWER8 processed used by an IBM DS8000™ enterprise storage system may have up to eight processor chips 300. Each chip 300 may contain up to six processor cores 302. Each processor core 302 may support several threads or tasks via simultaneous multi-threading (SMT). A POWER8 processor, for example, may operate up to eight threads or tasks per processor core 302.

As shown in FIG. 3, each processor chip 300 includes cache 304 for its respective processor cores 302. Each processor chip 300 also includes associated memory 214 (e.g., memory 214 that is closer to the processor chip 300). For example, the first processor chip 300a includes associated memory 214a. Similarly, the second processor chip 300b includes associated memory 214b. The processor cores 302 in each processor chip 300 may access their associated memory 214 faster than they can access the memory 214 of another processor chip 300. This is due to cache coherency operations (e.g., operations to ensure that cache 304 of the processor chips 300 contain valid data) and other overhead that may need to be performed when a processor core 302 accesses the memory 214 of another processor chip 300. These cache coherency operations are expensive and ideally avoided if possible. In certain embodiments, the architecture illustrated in FIG. 3 is based on non-uniform memory access (NUMA) as known to those of skill in the art.

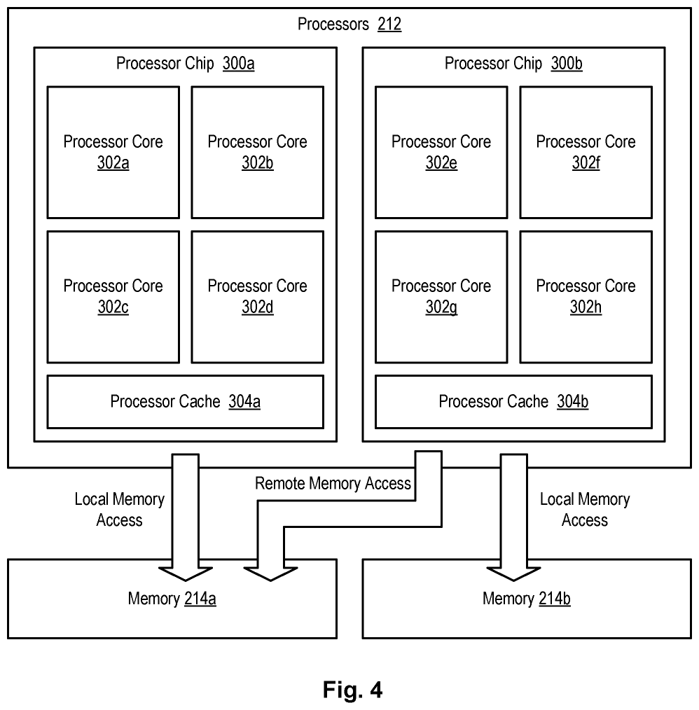

As shown in FIG. 4, a memory 214a may be located closer to a processor chip 300a and thus provide faster and more efficient access to cores 302a-d on the processor chip 300a. By contrast, the memory 214a may be located further from the processor chip 300b and thus provide slower and less efficient access to cores 302e-h on the processor chip 300b. Thus, more optimal performance may be provided when a processor core 302 accesses its own associated memory 214.

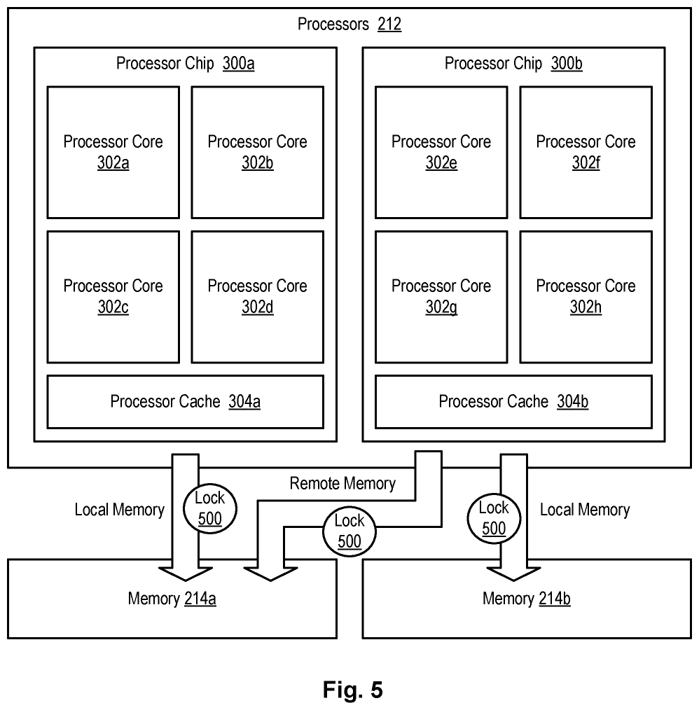

As shown in FIG. 5, each time a core 302, and more particularly a task or thread that is executing on a core 302, accesses data within a local (i.e., associated) or remote (i.e., non-associated) memory 214, a lock 500 may be needed to ensure that data integrity or validity is maintained. For the purposes of this disclosure, a “lock” may be defined as a data structure that controls access to a storage resource (e.g., memory, storage drives, or portions thereof). For example, a lock may be used to protect a storage resource such as a host I/O request queue. When code needs to add or remove an item from the storage resource, the code may acquire a lock in order to update the storage resource. The lock may provide serialization so that the storage resource is updated properly and so that data integrity is maintained.

As previously mentioned, when acquiring locks 500, cores 302 on a chip 300 may acquire locks 500 on their associated memory 214 faster than they can acquire locks 500 on the memory 214 of other processor chips 300. Thus, a processor core 302a-d within a chip 300a may acquire a lock faster and more efficiently within the associated memory 214a than can a processor core 302e-h within the chip 300b. Thus, where possible, a lock 500 is ideally obtained in memory 214 by a processor core 302 that resides in the associated processor chip 300.

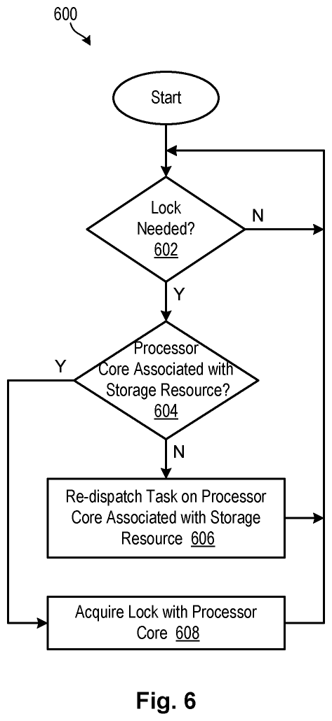

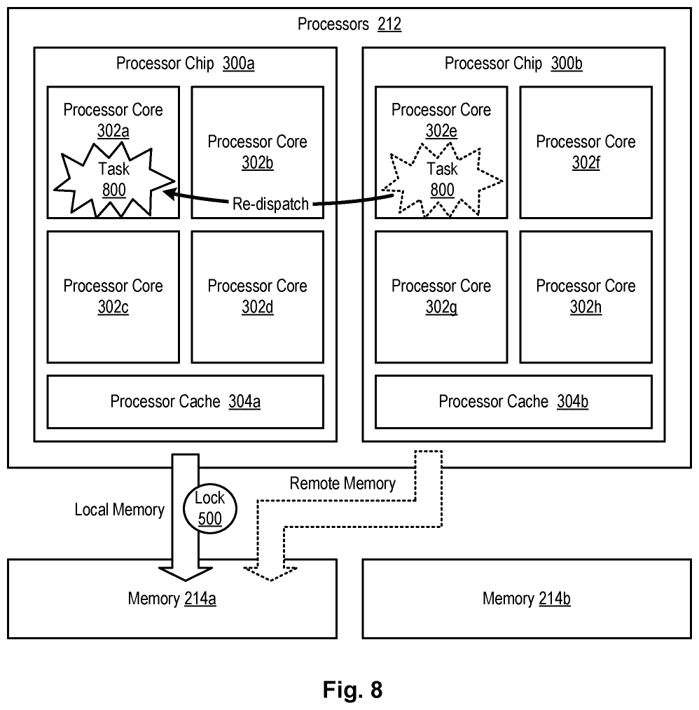

Referring to FIG. 6, while also referring generally to FIG. 8, one embodiment of a method 600 for reducing lock contention in a data storage system 110a is illustrated. Such a method 600 may, in certain embodiments, be executed by a task or in association with a task that is running in a data storage system 110a. As shown, when a task is running on a processor core 302, the method 600 determines 602 whether a lock 500 is needed to serialize a storage resource (e.g., a memory 214). This may be needed, for example, if the task needs to add or update data in the storage resource.

If so, the method 600 determines 604 if the processor core 302 on which the task is running is associated with the storage resource. If so, the method 600 acquires 608 the lock 500 with the currently-used processor core 302. If, on the other hand, the processor core 302 on which the task is running is not associated with the storage resource, the method 600 re-dispatches 606 the task on a processor core 302 that is associated with the storage resource. FIG. 8 shows an example of a task 800, executing on a processor core 302e, that is re-dispatched to a processor core 302a that is associated with a storage resource 214a. Re-dispatching the task 800 may include terminating the task 800 on the processor core 302e that was used prior to the re-dispatch operation (termination is shown by the dotted lines). Because the task 800 is re-dispatched to a processor core 302a that is associated with the storage resource 214a, the lock 500 may be acquired and/or released faster and more efficiently due to the ability to avoid overhead such as cache coherency operations. Although re-dispatching a task on an associated processor core 302 may take about 1-2 microseconds, acquiring a lock 500 with a non-associated processor core 302 may take on the order of milliseconds. The instant inventors have found that re-dispatching tasks from non-associated processor cores 302 to associated processor cores 302 may achieve performance gains on the order of twenty to thirty percent.

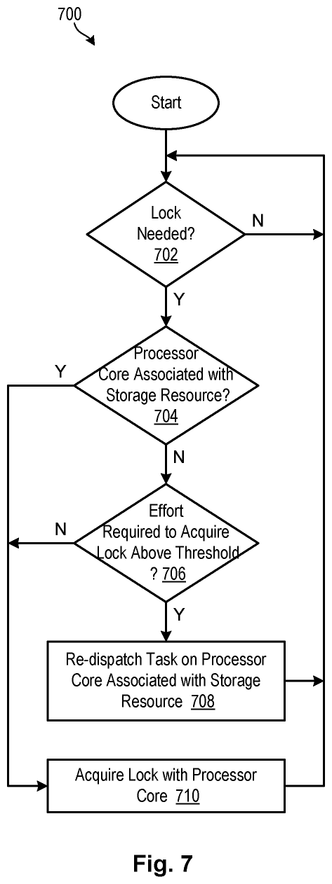

Referring to FIG. 7, another embodiment of a method 700 for reducing lock contention in a data storage system 110a is illustrated. The method 700 includes one additional step 706 compared to the method 600 of FIG. 6. Such a method 700 may be executed by or in association with a task that is running on a data storage system 110a. As shown, when a task is executing on a processor core 302 of the data storage system 110a, the method 700 determines 702 whether a lock 500 is needed to serialize a storage resource. If so, the method 700 determines 704 whether the processor core 302 on which the task is running is associated with the storage resource. If so, the method 700 acquires 710 the lock 500 with the processor core 302 on which the task is currently running.

If, on the other hand, the processor core 302 on which the task is running is not associated with the storage resource, the method 700 determines 706 whether effort required to acquire the lock 500 is above a threshold. This effort may be measured in terms of a number of clock cycles needed to acquire the lock 500, a number of acquisition attempts (e.g., retries) needed to acquire the lock 500, and/or an amount of time needed to acquire the lock 500. If the amount of effort required is below the threshold, the method 700 acquires 710 the lock 500 with the processor core 302 on which the task is currently running without performing a re-dispatch operation. In other words, even if the processor core 302 is not associated with the storage resource, the processor core 302 may nevertheless be used to acquire 710 the lock 500 if the amount of effort needed to acquire the lock 500 is below the threshold. If, on the other hand, the effort required to acquire the lock 500 is above the threshold, the method 700 re-dispatches 708 the task on a processor core 302 that is associated with the storage resource, as shown in FIG. 8. This may enable the lock 500 to be acquired faster and more efficiently than it could be without the re-dispatch operation.

Although apparatus and methods have been disclosed herein primarily as it relates to acquiring and releasing locks 500, similar apparatus and methods may be used with other types of operations. That is, other types of operations (e.g., data access operations) performed on a storage resource may benefit from being performed by associated processor cores 302 as opposed to non-associated processor cores 302. This is due to the fact that associated processor cores 302 are closer to the storage resources in which the operations are being performed and thus may be used to perform the operations more efficiently and with less overhead.

The flowcharts and/or block diagrams in the Figures illustrate the architecture, functionality, and operation of possible implementations of systems, methods, and computer-usable media according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for reducing lock contention in a data storage system, the method comprising:
dispatching, on a first processor core, a task configured to acquire a lock on a data storage resource;
determining whether the first processor core is associated with the data storage resource;
if the first processor core is not associated with the data storage resource, re-dispatching the task on a second processor core that is associated with the data storage resource; and
if the first processor core is associated with the data storage resource, executing the task on the first processor core.

2. The method of claim 1, wherein the first processor core is located on a first processor chip of a data storage system.

3. The method of claim 1, wherein the second processor core is located on a second processor chip of a data storage system.

4. The method of claim 1, wherein the storage resource is a memory.

5. The method of claim 1, wherein re-dispatching the task on the second processor core comprises re-dispatching the task on the second processor core only if effort required to acquire the lock is above a selected threshold.

6. The method of claim 5, wherein the effort required is measured by at least one of a number of clock cycles needed to acquire the lock, a number of acquisition attempts needed to acquire the lock, and an amount of time needed to acquire the lock.

7. The method of claim 1, wherein acquiring the lock on the data storage resource comprises acquiring the lock to access data on the data storage resource.

8. A computer program product for reducing lock contention in a data storage system, the computer program product comprising a computer-readable medium having computer-usable program code embodied therein, the computer-usable program code configured to perform the following when executed by at least one processor core:
dispatch, on a first processor core, a task configured to acquire a lock on a data storage resource;
determine whether the first processor core is associated with the data storage resource;
if the first processor core is not associated with the data storage resource, re-dispatch the task on a second processor core that is associated with the data storage resource; and
if the first processor core is associated with the data storage resource, execute the task on the first processor core.

9. The computer program product of claim 8, wherein the first processor core is located on a first processor chip of a data storage system.

10. The computer program product of claim 8, wherein the second processor core is located on a second processor chip of a data storage system.

11. The computer program product of claim 8, wherein the storage resource is a memory.

12. The computer program product of claim 8, wherein re-dispatching the task on the second processor core comprises re-dispatching the task on the second processor core only if effort required to acquire the lock is above a selected threshold.

13. The computer program product of claim 12, wherein the effort required is measured by at least one of a number of clock cycles needed to acquire the lock, a number of acquisition attempts needed to acquire the lock, and an amount of time needed to acquire the lock.

14. The computer program product of claim 8, wherein acquiring the lock on the data storage resource comprises acquiring the lock to access data on the data storage resource.

15. A system for reducing lock contention in a data storage system, the system comprising:
a data storage system comprising a first processor core, a second processor core, and a data storage resource, the data storage system configured to:
dispatch, on the first processor core, a task configured to acquire a lock on the data storage resource;
determine whether the first processor core is associated with the data storage resource;
if the first processor core is not associated with the data storage resource, re-dispatch the task on the second processor core that is associated with the data storage resource; and
if the first processor core is associated with the data storage resource, execute the task on the first processor core.

16. The system of claim 15, wherein the first processor core is located on a first processor chip of the data storage system and the second processor core is located on a second processor chip of the data storage system.

17. The system of claim 15, wherein the storage resource is a memory.

18. The system of claim 15, wherein re-dispatching the task on the second processor core comprises re-dispatching the task on the second processor core only if effort required to acquire the lock is above a selected threshold.

19. The system of claim 18, wherein the effort required is measured by at least one of a number of clock cycles needed to acquire the lock, a number of acquisition attempts needed to acquire the lock, and an amount of time needed to acquire the lock.

20. The system of claim 15, wherein acquiring the lock on the data storage resource comprises acquiring the lock to access data on the data storage resource.
